(19) United States
(12) Patent Application Publication
(10) Pub. No.: US 2024/0122192 A1
(43) Pub. Date: Apr. 18, 2024

(54) METHODS FOR PREPARING A STABILIZED DRINKING YOGHURT

(71) Applicant: Coöperatie Koninklijke Avebe U.A., Veendam (NL)

(72) Inventors: Jelle BRINKSMA, Eelderwolde (NL); Harm Jaap HELMENS, Wedde (NL)

(73) Assignee: Coöperatie Koninklijke Avebe U.A., Veendam (NL)

(21) Appl. No.: 18/278,240

(22) PCT Filed: Feb. 24, 2022
(86) PCT No.: PCT/NL2022/050106

§ 371 Date: Aug. 22, 2023

(30) Foreign Application Priority Data
Feb. 24, 2021 (EP) 21158887.6

(51) Int. Cl. A23C 9/137; A23C 9/12; A23C 9/13; A23C 9/154; A23L 29/212

(52) U.S. Cl. CPC A23C 9/137; A23C 9/1216; A23C 9/1307; A23C 9/1542; A23L 29/212; C12Y 204/01025; A23C 2220/106

(57) ABSTRACT

The invention relates to the field of food technology and fermented dairy products, more specifically to a novel drinking yoghurt and processes for the manufacture thereof. Provided is method to provide a stabilized drinking yoghurt, comprising the steps of: (i) dissolving powdered amylomaltase-treated starch (ATS) in an aqueous composition under heating to a temperature in the range of 50-80° C., preferably 60-75° C., more preferably 70-75° C., followed by (ii) cooling the solution to a temperature in the range of 2-45° C., preferably 4-25° C., more preferably 4-8° C., to induce the formation of an ATS gel; (iii) preparing a gelled yoghurt by either adding the ATS gel as pre-gel to a conventionally prepared fermented yoghurt, or wherein the ATS gel is formed in situ during the fermentation of a milk product into a yoghurt; and (iv) shearing the gelled yoghurt.

The invention relates to the field of food technology and fermented dairy products. More specifically, the invention relates to a novel drinking yoghurt and processes for the manufacture thereof.

Traditionally, yoghurt is produced by inoculation of milk with Lactobacillus delbrueckii subsp. bulgaricus and Streptococcus thermophilus as starter cultures. It is a traditional method to preserve milk through acidification. Before acidifying, necessary raw materials (such as sweetener, flavoring agents and texturizers) can be added to the milk, and the milk is then typically pasteurized and homogenized. The milk is acidified to a pH specific to each product. Three basic types of yoghurt exist, according to its physical state in the retail container: set yoghurt, stirred yoghurt and drinking yoghurt. Set yoghurt is fermented after being packed in a retail container, and stirred yoghurt is almost fully fermented in a fermentation tank before it is packed, the yoghurt gel (coagulum) being broken up during the stirring and pumping. Drinking yoghurt is a variant on stirred yoghurt, where the coagulum breaking step is more severe to yield a liquid, drinkable product.

With their refreshing light acid natural taste and high nutritional value, dairy drinks are very popular. A large selection of different sour milk drinks, which vary according to the manufacturing process, ingredients and consistency, is available to meet the needs of every consumer. In acidified milk drinks, milk protein flocculation and whey separation occur in the absence of stabilizers in acidified milk drinks. Casein is prone to aggregation at low pH, particularly when subjected to heat treatment. Thus, in the absence of a stabilizer, quality defects in these types of drinks include a high viscosity, whey exudation and sandy mouth feel.

In the late 1950s, it was shown that addition of high methyl ester (HM)-pectin to acidified milk drinks prevented the formation of sediment. A substantial portion of pectin today is used for the stabilization of low-pH dairy drinks, including fermented drinks and mixture of fruit juice and milk. The drinks may be heat-treated in order to increase their shelf life. Low viscosity and homogenous appearance are preferred characteristics.

A solution of HM-pectin is commonly used to stabilize acid dairy drinks in an addition of 0.1-0.3%. Quite often, a process for drinking yoghurt involves the mixing of a second aqueous phase to the stirred yoghurt, containing for instance flavours, sweeteners, hydrocolloids, fruit juice and so on. FIG. 1 shows a typical flow chart of a traditional manufacturing process of a drinkable yoghurt that is stabilised colloidally by the use of pectins.

Pectin is a soluble macromolecular substance of heteropolysaccharides obtained by mildly acidic aqueous extraction of plant material. The main sources are different fruits (dates, figs, prunes, apricot, raspberry, cherry and especially apple but mainly citrus). The backbone is D-galacturonic acid with α-1,4 glucosidic bonds, and rhamnose is also included. The overall solubility depends on the side chain constituents, typically consisting of galactose, glucose, rhamnose and arabinose. These side chains are lost when pectins are commercially processed.

The global pectin market is estimated to be valued at USD for more than 1 billion in 2019 and is projected to reach USD 1.5 billion (1691 million) by 2026, recording a CAGR of 6.1% during 2021-2026 (www.marketwatch.com). The market in Europe is estimated to account for the largest market share, but the Asia Pacific market is projected to grow at the highest CAGR coupled with the changing lifestyle there.

The price (US $4-100 per Kilogram) for pectin scatters by raw material, ordering amount, structural modification, ordering area (Europe/USA versus Asia Pacific) and quality. The price is affected by availability of crop year yields and supply and demand, but last two years increased for 20-30%, due to increasing demand. Furthermore, the quality of the fine structure of pectin is affected by many parameters, such as the origin of raw material and extraction conditions. This structural variability impacts greatly on pectin functional properties in (yoghurt drink) applications.

Thus, whereas pectin performs excellent in acid dairy stabilisation, it becomes increasingly expensive and moreover has the risk in fluctuation in quality and parameters to get a good processed product.

Accordingly, there is a strong desire in the market for pectin alternatives that can be used for preparing drinking yoghurts having a good storage/colloidal stability without compromising the organoleptic properties and nutritional value of drinkable yoghurt products.

Thus, an object of the present invention relates to the provision of means and methods for replacing conventional stabilizers, in particular pectin. The inventors specifically aimed at identifying a drinking yoghurt stabilizer that does not suffer from major fluctuations in quality, product parameters, (seasonal) supply and price. The stabilizer should be useful for providing a drinking yoghurt which does not show visible signs of syneresis (phase separation) upon storage at 4° C. for at least four days, e.g. up to one week, two weeks, or even longer. Moreover, it would be desirable that the new stabilizer is readily incorporated in conventional drinking yoghurt manufacturing processes.

It was surprisingly found that these goals can be obtained by including in the yoghurt an enzymatically modified starch. More in particular, the modified starch is an amylomaltase-treated starch (ATS) in the form of a sheared ATS gel. The ATS gel is formed by dissolving powdered ATS in an aqueous composition under heating to a relatively mild temperature, i.e. avoiding excessive heating such as jet-cooking, followed by cooling the ATS solution to induce the formation of an ATS gel.

According to the invention, the ATS gel can either be formed in situ during the conventional yoghurt manufacturing process, or the ATS gel can be added as pre-gel to a conventionally prepared fermented yoghurt. It was found that this novel approach is advantageously used to stabilize a drink yoghurt, either skimmed, semi-skimmed or full fat, up to at least 19 days of storage at 4° C. Importantly, the storage stability was improved as compared to that of conventionally used pectin.

Therefore, the invention relates to a method to provide a stabilized drinking yoghurt, comprising the steps of:
(i) dissolving powdered amylomaltase-treated starch (ATS) in an aqueous composition under heating to a temperature in the range of 50-80° C., preferably 60-75° C., more preferably 70-75° C., followed by
(ii) cooling the solution to a temperature in the range of 2-45° C., preferably 4-25° C., more preferably 4-8° C., to induce the formation of an ATS gel;
(iii) preparing a gelled yoghurt by either adding the ATS gel as pre-gel to a conventionally prepared fermented yoghurt, or wherein the ATS gel is formed in situ during the fermentation of a milk product into a yoghurt; and
(iv) shearing the gelled yoghurt.

In one embodiment, the invention provides a method to provide a stabilized drinking yoghurt, comprising the steps of: (i) dissolving powdered amylomaltase-treated starch (ATS) under heating to a temperature in the range of 50-80° C. into a formulated milk prior to and/or during pasteurization, (and prior to fermentation); (ii) cooling the ATS-supplemented milk to a temperature in the range of 2-45° C. to induce the in situ formation of an ATS gel during fermentation of the milk into a gelled yoghurt; and (iii) shearing the gelled yoghurt to obtain a drinking yoghurt, and wherein the temperature remains below 80° C. during all steps of the drinking yoghurt manufacturing process following ATS addition.

In another embodiment, the invention provides a method to provide a stabilized drinking yoghurt, comprising the steps of (i) dissolving powdered amylomaltase-treated starch (ATS) in an aqueous composition under heating to a temperature in the range of 50-80° C., followed by (ii) cooling the solution to a temperature in the range of 2-45° C., preferably 4-25° C., more preferably 4-8° C., to induce the formation of an ATS gel; (iii) preparing a gelled yoghurt by adding the ATS gel as a pre-formed gel to a conventionally prepared fermented yoghurt; and (iv) shearing the gelled yoghurt.

Also provided herein is a method to increase the storage stability of a drinking yoghurt, in particular a pectin-free drinking yoghurt, which method comprises the above mentioned steps.

As used herein, the term “drinking yoghurt” (also: “drinkable yoghurt” or “yoghurt drink”) refers to any type of drinkable yoghurt composition. Drinking yoghurts are fermented beverages with a protein base (dairy or plant-based). This category utilizes a fermentation process that induces a drop in pH from a neutral to an acidic environment. Yoghurt drinks can come in portion packs, making them easy to consume on-the-go and a healthy product for quick eating. Yoghurt drinks are often flavored with fruit or fruit juice and can be enriched with vitamins, minerals and pre- or probiotics.

The use of ATS in a food or drink item is also known in the art. However, a method of the invention involving dissolving powdered amylomaltase-treated starch (ATS) in an aqueous composition under heating to a temperature in the range of 50-80° C., followed by cooling the solution to induce the formation of an ATS gel was heretofore not disclosed.

WO2008/071744 (see also U.S. Pat. No. 10,080,373) in the name of the applicant relates to the application of amylomaltase-treated starch to substitute cream and/or fat in food products. It was found that by employing amylomaltase-treated starches well below the concentration at which they form a continuous gel, a good replacer for fat and/or cream is obtained in many food products such as dairy products, soy-protein based products such as soy-based drinks and desserts, dressings and mayonnaises. Example 3 of WO2008/071744 discloses drink yoghurt products comprising up to 0.7 wt % ATS. The ATS was included by adding a dry mix of sugar and ATS to standardized and homogenized milk and allowed to hydrate. Then, the milk including ATS was pasteurized for 10 minutes at 90° C. and cooled back to fermentation temperature. This procedure is significantly different from that of the present invention, wherein ATS is dissolved in an aqueous composition under heating to 50-80° C., i.e. at a lower temperature. As is demonstrated herein below, this reduced dissolution temperature is essential to obtain an ATS gel having the desired stabilizing properties. Without wishing to be bound by theory, intermolecular interactions may occur between ATS molecules during dissolution at mild heating temperatures. Excessive heating temperatures, such as employed during jet-cooking, will disrupt such phenomena thereby affecting the structure of the ATS gel that is formed upon cooling.

WO2012/111326 relates to a method for producing aging-resistant enzyme-treated starch granules, and the use thereof in food products, including beverages. According to WO2012/111326, an aqueous suspension of starch granules is treated with an 4-α-glucanotransferase, such as amylomaltase, at a temperature that is not greater than the gelatinization onset temperature of the starch granules, which is the range of about 63° C. to 73° C., depending on the type of starch. For example, the gelatinization onset temperature of potato starch is about 62.6° C. The enzyme-treated starch granules can then be mixed with food material, and heated under the same conditions used in the usual production method of the intended food. WO2012/111326 is silent about dissolving powdered amylomaltase-treated starch (ATS) in an aqueous composition under heating to a temperature in the range of 50-80° C.

Step (i) of a method herein disclosed comprises dissolving powdered amylomaltase-treated starch (ATS) in an aqueous composition under heating to a temperature in the range of 50-80° C., preferably 60-75° C., more preferably 70-75° C. For example, very good results can be obtained when ATS is dissolved and heated to a maximum of 75° C., like 70, 71, 72, 73, 74 or 75° C. The rate of heating is 1-25° C. per minute, preferably 5-10° C. per minute. Excessive heating is avoided to prevent overheating at the wall of the heating element, i.e. heating spiral or reaction vessel. Preferably, a method of the invention comprises dissolving powdered, non-granular, cold water swellable ATS in an aqueous composition under heating to a temperature in the range of 50-80° C.

Amylomaltase-treated starch (ATS) is a modified starch obtainable by treating amylose-containing starch in aqueous medium with amylomaltase, an enzyme from the group of α-1,4-α-1,4-glucosyl transferases (EC 2.4.1.25).

See for example EP 932444B1 in the name of the applicant, disclosing the enzymatic conversion with glucosyl transferase carried out on either gelatinized starch, or starch that is still in a granular form but in a swollen state, or, in other words, on starch that is only partially gelatinized. In the former case, enzyme can be added to a gelatinized starch solution obtained e.g. by jet-cooking, after it has cooled to the desired reaction temperature. In the latter case, an aqueous starch suspension is prepared to which the enzyme is added at any desired moment

The amylose-containing starch can be derived from various sources known in the art. For example, it is a potato starch, a maize starch, a wheat starch, a rice starch, or a tapioca starch. In a specific aspect, the ATS is amylomaltase-treated potato starch.

It was surprisingly found that ATS has very good stabilizing properties in a drinking yoghurt when ATS is prepared in a process that avoids excessive (>85° C.) heating of starch, such as dissolving starch and/or enzyme inactivation by jet-cooking. See Example 3 demonstrating that a stable drink yoghurt is obtained when the ATS-gel is prepared by dissolving ATS at a temperature below 85° C.

Accordingly, in one embodiment step (i) comprises dissolving powdered (cold water swellable) ATS in an aqueous composition under heating to a temperature in the range of 50-80° C. The ATS for step (i) has been obtained by treating an amylose-containing starch suspension with amylomaltase (EC 2.4.1.25). Preferably, the enzyme treatment comprises adding amylomaltase to an amylose-containing starch suspension (slurry) at a temperature below the gelatinization temperature (about 20° C.-50° C.) followed by gradually heating the suspension to a temperature above the gelatinization temperature of the starch, typically in the range of about 60-75° C., and avoiding any heating above 85° C., thereby obtaining a cold water swellable starch after drying. The starch suspension may contain about 10-25 wt %, preferably 15-25 wt %, like about 18, 19, 20, 21, 22, 23 or 24 wt %, of an amylose-containing starch in water. In a specific aspect, a suspension of about 20 wt % potato starch is used. The general conditions for enzyme treatment are described in EP 932444B1. The conditions described in EP932444B1 result in a non-granular cold water swellable ATS.

For example, a starch slurry is prepared by suspending potato starch (6 kg) in tap water (1:4 (w/v)) and this suspension is transferred directly into a double walled reactor heated to 50° C. The pH is adjusted to about 6-6.5, e.g. pH 6.2, and enzyme (about 3-3.5 U/g starch) is added to the stirred reaction mixture. After addition of the enzyme, the temperature is increased gradually to 70° C., for example in steps of about 2-5° C. per 15 min. After stirring for 19 h at 70° C., the reaction mixture is diluted with tap water to Brix<7% and spray dried to give powdered cold water swellable amylomaltase treated starch (ATS) as a white solid (4 kg yield, 6.0% moisture content).

As indicated above, according to step (ii) a method of the invention comprises cooling an aqueous solution of ATS to a temperature in the range of 2-45° C., preferably 4-25° C., more preferably 4-8° C., to induce the formation of an ATS gel. The ATS gel is in step (iii) incorporated in a gelled yoghurt, which incorporation may either comprise adding a “pre-gelled” ATS gel to a conventionally prepared fermented yoghurt, or wherein the ATS gel is formed in situ during the fermentation of a milk product into a drinking yoghurt.

In one embodiment, the invention provides a method to provide a stabilized drinking yoghurt, comprising the steps of dissolving powdered amylomaltase-treated starch (ATS) into a formulated milk composition under heating to a temperature in the range of 50-80° C., preferably in a concentration of 0.1 to 2 wt % ATS based on total milk, followed by forming an ATS gel in situ during the fermentation of a milk product into a yoghurt by cooling to a temperature in the range of 2-45° C. For example, powdered ATS is suitably dissolved in (skimmed) milk, which ATS-supplemented milk is then processed into a yoghurt according to an otherwise conventional process.

FIG. 1 depicts a process of manufacturing a drinking yoghurt, wherein an ATS gel is formed in situ. Addition of ATS can take place at one or more of the indicated steps. For example, powdered ATS can be combined with on one more liquid components (tap water, fruit juice, skimmed milk and/or cream) in the first step to yield a standardized milk with a desired fat, protein and carbohydrate content. Addition to tap water is particularly preferred. It can also be combined with dry components such as skimmed milk powder or sugar.

Accordingly, a method of the invention may comprise (i) dissolving powdered ATS into a formulated milk prior to and/or during pasteurization and prior to fermentation; and (ii) cooling the resulting liquid such that (iii) the ATS gel forms in situ during fermentation thereby preparing a gelled yoghurt which (iv) is subsequently sheared. Also in this method, the temperature remains below 80° C., preferably below 75° C., during all steps of the drinking yoghurt manufacturing process following ATS addition. For example, the method comprises including amylomaltase-treated starch (ATS) in an otherwise conventional manufacturing process for preparing a drinking yoghurt by fermentation of milk, and wherein said method comprises the steps of (i) dissolving powdered ATS in an aqueous component conventionally used in the drinking yoghurt manufacturing process under heating to a temperature in the range of 50-80° C., preferably 60-75° C.; followed by (ii) cooling the solution to a temperature in the range of 2-45° C. to induce the formation of an ATS gel; (iii) allowing the milk to ferment to yoghurt; followed by (iv) shearing the ATS gel to obtain a drinking yoghurt that is stabilized with a sheared ATS gel.

In another embodiment, the ATS is added as a pre-formed ATS gel to a yoghurt. For example, in step (i) ATS is dissolved in an aqueous composition under heating to a temperature in the range of 50-80° C., after which in step (ii) an ATS gel is obtained by cooling to a temperature between 2° C. and 30° C., preferably between 4° C. and 25° C., more preferably 4 to 8° C. For example, a pre-formed ATS gel is prepared in water, milk, fruit juice, skimmed yoghurt, semi-skimmed yoghurt or full-fat yoghurt. In a preferred embodiment, a pre-formed ATS gel is prepared in water or fruit juice. Good results are obtained when the ATS concentration in the pre-formed ATS gel is between 3 and 15 wt %, preferably 5-12 wt %. Thereafter, in step iii) the ATS gel is added to a yoghurt and the resulting composition is in step (iv) sheared (homogenized) to provide a stabilized drinking yoghurt. The pre-formed ATS gel needs to be sheared to a flowing mass before it is added and stirred into a yoghurt. Shearing can be performed by methods and equipment generally known in the art, for example using a High shear homogenizer or high pressure homogenizer.

FIG. 2 depicts a process of manufacturing a drinking yoghurt wherein ATS is added as a sheared pre-gel to a set or stirred yoghurt. The addition of pre-gelled ATS can take place at one or more of the indicated steps. For example, a pre-formed ATS gel is prepared in water, milk, fruit juice, skimmed yoghurt, semi-skimmed yoghurt or full-fat yoghurt, after which it is sheared and combined in the product stream. Preferably, ATS pre-gel is prepared in water or fruit juice. ATS can be added to the yoghurt instead of pectin solution, combined with sugar or with the fruit (juice). In case of pre-gelling, ATS is separately pasteurized, because otherwise the pre-gelled ATS goes in solution again, so it must be added as pre-sheared ATS-gel between the pasteurization and packaging step of the yoghurt preparation process.

In a method according to the invention, comprising either in situ ATS gel formation or the addition of ATS as a sheared pre-gel, the resulting composition is sheared. It was found that shearing the ATS gel to obtain particles characterized by a d-50 of less than about 20 μm gives a very stable product.

The amount of ATS to be incorporated in the drinking yoghurt can vary, e.g. according to other yoghurt constituents, such as the fat content, and can be optimized using common general knowledge. The addition of ATS in a concentration of about 0.1 to 2 wt %, e.g. 0.2 to 1.5 wt %, 0.2 to 1.2 wt %, 0.4 to 1 wt %, 0.1 to 0.5 wt %, 0.1 to 0.3 wt %, 0.3 to 1 wt %, or 0.2 to 0.5 wt %, was found to have good stabilizing effects. A method according to the invention is suitably used to provide a skimmed, semi-skimmed or full-fat drinking yoghurt.

Also provided herein is a stabilized drinking yoghurt obtainable by a method as herein disclosed. Such drinking yoghurt can, among others, be characterized in that it shows no detectable syneresis and/or sedimentation upon storage at 4° C. for at least 7 days, preferably at last 10 days, more preferably at least 14 days. The invention provides a skimmed, semi-skimmed or full-fat drinking yoghurt. Preferably, the concentration of ATS in the stabilized drinking yoghurt is between 0.1 and 2 wt %, for example 0.2 to 1.5 wt %, 0.2 to 1.2 wt %, 0.4 to 1 wt %, 0.1 to 0.5 wt %, 0.1 to 0.3 wt %, 0.3 to 1 wt %, or 0.2 to 0.5 wt %.

A further aspect of the invention relates to various uses of amylomaltase-treated starch (ATS) that is obtained by incubating an amylose-containing starch suspension, which suspension has not been subjected to jet-cooking, with amylomaltase (EC 2.4.1.25). The starch suspension may contain about 10-25 wt %, preferably 15-25 wt %, like about 18, 19, 20, 21, 22, 23 or 24 wt %, of an amylose-containing starch in water. In a specific aspect, a suspension of about 20 wt % potato starch is used. Preferably, the ATS is obtained by adding amylomaltase to the amylose-containing starch suspension at about room temperature, followed by gradually heating to a temperature in the range of about 60-75° C.

In one embodiment, this type of ATS is used as a stabilizer in a drinking yoghurt. Also provided is the use of ATS as a pectin replacer in a liquid food product, wherein the ATS is obtained by incubating an amylose-containing starch suspension, which suspension has not been subjected to jet-cooking, with amylomaltase (EC 2.4.1.25). Still further, the invention provides the use of ATS to enhance the colloidal stability of a fermented diary product, wherein the ATS is obtained by incubating an amylose-containing starch suspension, which suspension has not been subjected to jet-cooking, with amylomaltase (EC 2.4.1.25).

### LEGEND TO THE FIGURES

FIG. 1: Schematic outline of a drinking yoghurt manufacturing process, including the possible steps at which ATS can be added in the in situ method.

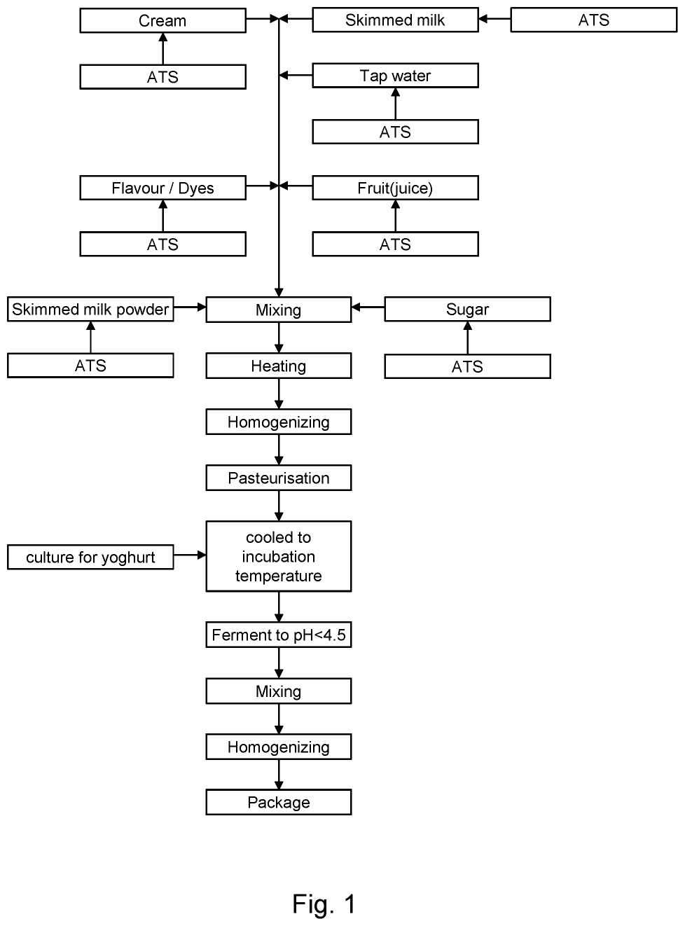

FIG. 2: Schematic outline of a drinking yoghurt manufacturing process, including the possible steps at which ATS can be added as pre-gel.

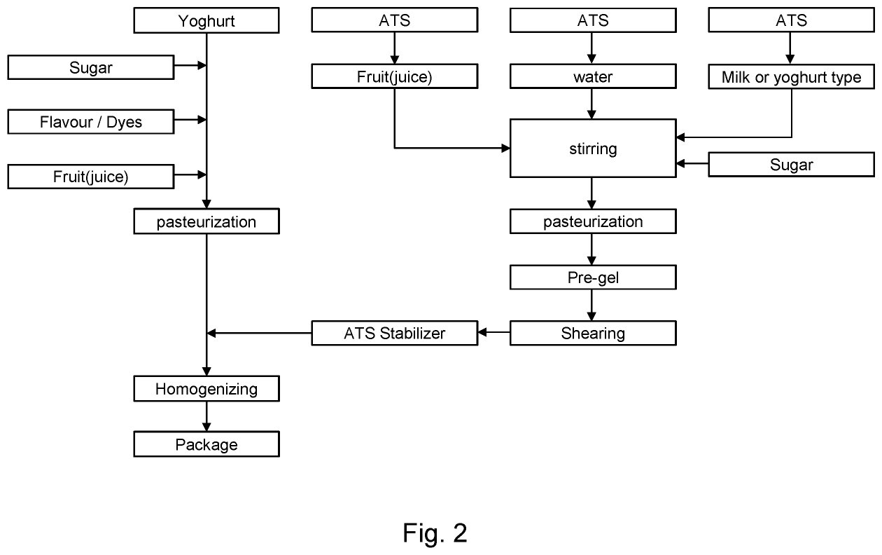

### EXPERIMENTAL SECTION

### Material and Methods

### Amylomaltase Treated Starch (ATS)

A starch slurry was prepared by suspending potato starch as is (2 kg) in tap water (1:4 w/w) at 20° C. and this slurry was transferred directly into a double walled reactor heated to 50° C. The pH was adjusted to 6.2 using H₂SO₄ (5 M) and amylomaltase (3.2 U/g starch, 3.9 ml) was added to the stirred reaction mixture. After addition of the enzyme, the temperature was increased to 70° C. in steps of 2.5° C. per 15 min. After stirring at 100 rpm for 19 h at 70° C., the reaction mixture was diluted with tap water to Brix<7% and spray dried (250° C. inlet; 110° C. outlet) to give the ATS product as a non-granular cold water swellable white solid (1.5 kg yield, 6.0% moisture content).

One amylomaltase unit (ATU) is defined as the amount of amylomaltase which produces 1 μmol of glucose per minute under the assay conditions of the test. Assay: Amylomaltase is incubated with maltotriose at pH 6.50 and 70° C., releasing glucose from the substrate. The incubation is stopped by adding hydrochloric acid. The amount of released glucose is a measure for the amylomaltase activity and is examined using a glucose test assay (NADH formation) on a Selectra analyzer at a wavelength of 340 nm

### Viscosity Measurements

Viscosity was measured with a Brookfield LVDVII with helipath spindel C (Sp93) at 10 RPM at 4-6° C. Measurements were always performed in duplicate. The viscosity after 30 seconds was recorded in [mPas].

### Particle Size

The d-50 is a common parameters to express the particle size distribution. The d-50 is the volume median particle size, and indicates the diameter, in μm, that splits the distribution into two equal fractions, wherein half of the particle volume has a diameter above the median diameter, and wherein half of the particle volume has a diameter below the median diameter. It can also be referred to as Dv50. The particle size can be determined by laser diffraction using a Sympatec HELOS equipped with QUIXEL wet dispersing system. Particle sized is calculated by the integrated software using the “fraunhofer” Formula applying a shape factor of 1.

### Example 1: In-Situ ATS Gel Formation in Semi-Skimmed Yoghurt

This example exemplifies the stabilization of a drink yoghurt by ATS gel formation in situ during the yoghurt manufacturing process. To that end, powdered ATS is added to milk and dissolved in the milk during the pasteurization of milk at 72° C. The pasteurized ATS-supplemented milk is then subjected to a standard process for yoghurt production. During the fermentation step, an ATS gel is formed in-situ. After shearing of the gelled yoghurt, a drink yoghurt is obtained.

It also shows the effect of the pasteurization temperature of the ATS-supplemented milk on the stability of the final drinking yoghurt. More specifically, a direct comparison is made with Example 3 of WO2008/071744 disclosing a drink yoghurt obtained from milk comprising 0.5 wt % ATS that was pasteurized for 10 minutes at 90° C.

Skimmed milk and semi-skimmed milk from the grocery store were standardized to obtain 900 g milk comprising 1.0% fat, 4.8% sugar and 3.6% protein.

A dry mixture of 95 g sugar and 5 g ATS (dry powder) was added to the semi-skimmed milk and stirred to hydrate for 10 minutes. The milk was pasteurized during 10 minutes at either 72° C. or 90° C., followed by cooling to 32° C. After the addition of 1 ml lactic acid bacteria stock culture CSK G700.6, the milk was allowed to ferment overnight to pH<4.6 at 32° C. The resulting yoghurts were smoothened by shearing with the IKA Ultra-Turrax T50 at 10.000 rpm. The smoothened yoghurts were filled out in 100 gram portions into plastic 120 ml containers, closed with a screw-on cap and placed into a blast chiller at 4° C. overnight and then stored at same temperature. Stability of the yoghurts was assessed after 0, 4, 11, 15 and 19 days by viscosity measurements and by visual inspection.

TABLE 1
Effect of pasteurization temperature on stability

| | | Past. | | | | | | |
|---|---|---|---|---|---|---|---|---|
| | ATS | T | | | t = 4 | t = 11 | t = 15 | t = 19 |
| | [wt %] | [° C.] | | t = 0 | days | days | days | days |
| Comp. | 0.50% | 90 | Viscosity | 3800 | 5600 | 6800 | 9800 | — |
| Ex. | | | [mPas] | | | | | |
| | | | Visual | Stable | Lumps | Lumps | Lumps | sediment |
| Invention | 0.50% | 72 | Viscosity | 3800 | 4200 | 4600 | 4200 | 3700 |
| | | | [mPas] | | | | | |
| | | | Visual | Stable | Stable | Stable | Stable | Stable |

This experiment shows that preparing a drink yoghurt according to the method of WO2008/071744 does not provide a drink yoghurt which remains stable over a prolonged storage time. In contrast, heating of the ATS-supplemented milk to only 72° C. resulted in a stable product up to at least 19 days.

### Example 2: Stabilization of a Full Fat Drink Yoghurt

In this example, a full fat drink yoghurt is prepared by including powdered ATS in milk prior to pasteurization. Different concentrations (0.0; 0.1, 0.2, 0.4 or 0.5 wt %) of ATS were used. See table 2 for the recipes.

First, a 10% starter culture stock solution was made by heating 90 g of the skimmed milk to 40-50° C. in a sterile beaker and dissolving 10 g of Delvo culture (DSM, Batch FVV-221).

Skimmed milk, cream and tap water were weighted into a Thermomix bowl A dry mixture of sugar and ATS (dry) was added to the milk and stirred to hydrate for 15 minutes to obtain an ATS-supplemented full fat milk.

TABLE 2

| Recipe | 1 | 2 | 3 | 4 | 5 |
|---|---|---|---|---|---|
| skimmed milk [g] | 1000 | 1000 | 1000 | 1000 | 1000 |
| Cream [g] | 45 | 45 | 45 | 45 | 45 |
| skimmed milk | 55 | 55 | 55 | 55 | 55 |
| powder [g] | | | | | |
| ATS (dry) [g] | 6.0 | 4.8 | 2.4 | 1.2 | 0 |
| Sugar [g] | 7 | 8 | 10 | 11 | 12 |
| Tap water [g] | 88 | 88 | 88 | 88 | 88 |
| Total [g] | 1201 | 1200.8 | 1200.4 | 1200.2 | 1200 |
| % ATS | 0.5 | 0.4 | 0.2 | 0.1 | 0 |

The ATS-supplemented full fat milks were heated to 60° C. and homogenized in the NIRO Soavi at 150/50 Bar. The milks were heated in a Thermomix bowl to pasteurize during 10 minute at 72° C., and then cooled down to 43° C. Following addition of 2 ml culture stock solution, the milks were allowed to ferment overnight to pH<4.6 at 43° C. This also induced the formation of an ATS gel in situ.

The gelled yoghurts were smoothened by shearing with the IKA Ultra-Turrax T50 homogenizer at 10,000 rpm. The smoothened yoghurts were filled out in 100 gram portions of plastic 120 ml containers, closed with a screw-on cap and stored into the blast chiller at 4° C. overnight and then stored at same temperature.

TABLE 3
Evaluation of concentration in full fat drink yoghurt

| | | Past. | | | | | | |
|---|---|---|---|---|---|---|---|---|
| | ATS | T | | | t = 1 | t = 4 | t = 11 | t = 15 |
| Exp. | [wt %] | [° C.] | Result | t = 0 | day | days | days | days |
| 1 | 0.50 | 72 | Viscosity | 6500 | | 7600 | | 8500 |
| | | | [mPas] | | | | | |
| | | | Visual | Stable | | Stable | | Stable |
| 2 | 0.40 | 72 | Viscosity | 4800 | 5400 | | 6400 | |
| | | | [mPas] | | | | | |
| | | | Visual | Stable | Stable | | Stable | |
| 3 | 0.20 | 72 | Viscosity | 5700 | 6300 | | 6700 | |
| | | | [mPas] | | | | | |
| | | | Visual | Stable | Stable | | Stable | |
| 4 | 0.10% | 72 | Viscosity | 4900 | 5900 | | 6300 | |
| | | | [mPas] | | | | | |
| | | | Visual | Stable | Stable | | Stable | |
| 5 | 0.00% | 72 | Viscosity | 4700 | 5500 | | | |
| | | | [mPas] | | | | | |
| | | | Visual | Stable | Stable | | Sediment | |

This experiment shows that the addition of ATS at concentrations as low as 0.10 wt % can enhance the stability of a drink yoghurt

### Example 3: Influence of ATS Dissolution Temperature on Stability

This example demonstrates that the temperature at which amylomaltase-treated starch (ATS) is dissolved is of relevance for the stabilizing properties of ATS when added as a pre-gel.

Powdered ATS was added to tap water of about 20° C. under stirring to obtain a 5 wt % dispersion. The dispersion was heated to either 60, 65, 72, 85 or 90° C., and held at the same temperature for at least 10 minutes. The dispersions were stored at 4° C. for at least 16 hours to allow the formation of an ATS pre-gel. The cold soft ATS gelled material was sheared 3 times with an IKA Magic Lab with turrax tool at 10,000 rpm. This material is herein referred to as sheared ATS pre-gel.

The different sheared ATS pre-gels were then included in a drinking yoghurt.

730 grams of skimmed yoghurt (<4.8 wt % protein, <4.0 wt % Carbohydrates/sugar and <0.3 wt % fat) from the grocery store was weighed in a 1000 ml plastic beaker. 70 grams of sugar and 200 grams of the pre-gelled and sheared ATS material (5% d.s.) were added. The mixture was stirred with a spoon and homogenized 3 times through the IKA Magic Lab with turrax tool at 10,000 rpm.

The smoothened drink yoghurt was filled as 100 grams portions into plastic 120 ml containers, closed with a screw-on cap and stored at 4° C. to induce gelation. After 4, 12 and 26 days, stability was assessed by visual inspection.

TABLE 4
Effect of ATS dissolution temperature
on stability of drinking yoghurt

| ATS pre- | Dissolution | Gelation | Visual evaluation | | |
|---|---|---|---|---|---|
| gel | temperature | temperature | t = 4 | t = 12 | t = 26 |
| [wt %] | [° C.] | [° C.] | days | days | days |
| 0 | — | — | Phase | | |
| | | | separation | | |
| 1 | 60 | 4 | Stable | Stable | n.a. |
| 1 | 65 | 4 | Stable | Stable | n.a. |
| 1 | 72 | 4 | Stable | Stable | Stable |
| 1 | 85 | 4 | Cracks | Cracks | Phase |
| | | | | | separation |
| 1 | 90 | 4 | Cracks | Cracks | Phase |
| | | | | | separation |

n.a. not assessed

The results in Table 4 show that no stable drinking yoghurt is obtained when ATS gel is prepared from powdered ATS that was dissolved at a temperature of 85 or 90° C. However, when the starch gel is prepared by dissolution of ATS at 60, 65 or 72° C., drinking yoghurts are obtained that are stable for at least 26 days. Preferably, the ATS gels are prepared from powdered ATS dissolved at a temperature higher than 60° C., more preferably at least 65° C.

### Example 4: Criticality of Maximum Dissolution Temperature

This example elaborates further on the observations of Example 3 that a reduced ATS dissolution temperature has a profound effect on the capacity of ATS to confer stability to drinking yoghurts.

| Composition | |
|---|---|
| Skimmed yoghurt (g) | 730 |
| Sugar (g) | 70 |
| ATS Pre-gel (5% d.s.) (g) | 200 |
| total (g) | 1000 |

The experimental set-up was identical to that of Example 3, except for that the dissolution of powdered ATS was performed at the following temperatures: 72, 75, 78, 81 and 85° C. Gelation was performed at 4° C. in all cases. All yoghurts were analyzed (visual inspection and viscosity measurements) after 7, 21 and 28 days cold storage (4° C.).

The results in Table 5 demonstrate that when ATS gel is prepared by dissolving the ATS at a temperature up to and including 78° C., drink yoghurts were obtained which remained stable during cold storage for at least 4 weeks. A dissolution temperature of 81° C. resulted in some stability up to about 1-2 weeks. However, no stability was observed when the ATS gel was prepared by dissolution at 85° C. Taken together, these data indicate that a dissolution temperature in the range of 50-80° C. is important to confer a substantive stability to a drinking yoghurt.

TABLE 5

| | | Product Evaluation | | | | | |
|---|---|---|---|---|---|---|---|
| | Dissolution | t = 7 days | | t = 21 days | | t = 28 days | |
| ATS | temperature | | Viscosity | | Viscosity | | Viscosity |
| [wt %] | [° C.] | Visual | [mPas] | Visual | [mPas] | Visual | [mPas] |
| 0 | — | phase | n.a. | | | | |
| | | separation | | | | | |
| 1 | 72 | Stable | 3300 | Stable | 3900 | n.a. | 4600 |
| 1 | 75 | Stable | 3900 | Stable | 3950 | n.a. | 4450 |
| 1 | 78 | Stable | 4200 | Stable | 4400 | Stable | 4650 |
| 1 | 81 | Stable | 4000 | Cracks | 4150 | phase | n.a. |
| | | | | | | separation | |
| 1 | 85 | Cracks | 3900 | Cracks | 10000 | phase | 17000 |
| | | | | | | separation | |

### Example 5: Skimmed Drinking Yoghurt Stabilization Using ATS Pre-Gel

This example describes the manufacture of a stabilized skimmed drinking yoghurt by the addition of a pre-gelled ATS prepared from powdered ATS that was dissolved in skimmed yoghurt. It also shows that the dissolution temperature, but not the gelation temperature, is of relevance for the stabilizing properties of the ATS pre-gel.

Skimmed yoghurt (0% fat, 4% sugar and 4.7% protein) was obtained from a local grocery store. A solution of 10% (w/v) ATS in skimmed yoghurt was prepared by adding the starch, stirring and heating to either 72° C. or 90° C. for at least 10 minutes. The solutions were cooled in flowing tap water. Half of the solution was stored at room temperature (about 25° C.) and the other half at 4° C. for at least 16 hours, and allowed to gel.

The resulting preparations were sheared in the Ika Magic-lab at 12.500 rpm to a thin fluid, representing the sheared ATS pre-gel. 150 ml pre-sheared gel was diluted with 250 ml tap water. The pre-sheared ATS gel was added to 70 grams sugar and 530 grams standardized semi-skimmed yoghurt.

All yoghurt preparations were sheared three times through the Ika MagicLab at 12,500 rpm to obtain a drinking yoghurt. The prepared drinking yoghurts were filled in portions of 100 grams into plastic 120 ml containers, closed with a screw-on cap and stored at 4° C. The viscosity of the drinking yoghurts was assessed prior to storage, and after 4, 11 and 15 days of storage at 4° C. Results are shown in Table 6.

TABLE 6
Effect of ATS dissolution temperature and gelation
temperature on stability of drinking yoghurt.

| ATS | Dissolution | Gelation | Viscosity | | | |
|---|---|---|---|---|---|---|
| Pre-gel | temperature | temperature | t = 0 | t = 4 | t = 11 | t = 15 |
| [wt %] | [° C.] | [° C.] | [mPas] | [mPas] | [mPas] | [mPas] |
| 1.5 | 72 | 4 | 2,200 | 2,500 | 2,600 | 5,500 |
| 1.5 | 72 | 25 | 2,400 | 2,800 | 4,900 | 4,400 |
| 1.5 | 90 | 4 | 2,200 | 3,500 | broken | broken |
| 1.5 | 90 | 25 | 2,400 | lumps | lumps | lumps |

As shown in Table 4, stable drinking yoghurts were obtained from ATS pre-gel that was prepared by dissolution at 72° C. or lower, and gelation at either 4° C. or 25° C. In contrast, when the ATS gel was prepared by dissolving the starch at 90° C. and allowing for gelation at 4° C. or 25° C., no stable drinking yoghurt was obtained.

1. A method to provide a stabilized drinking yoghurt, comprising the steps of
(i) dissolving powdered amylomaltase-treated starch (ATS) under heating to a temperature in the range of 50-80° C. into a formulated milk prior to and/or during pasteurization;
(ii) cooling the ATS-supplemented milk to a temperature in the range of 2-45° C. to induce the in situ formation of an ATS gel during fermentation of the milk into a gelled yoghurt; and
(iii) shearing the gelled yoghurt to obtain a drinking yoghurt, and wherein the temperature remains below 80° C. during all steps of the drinking yoghurt manufacturing process following ATS addition.

2. A method to provide a stabilized drinking yoghurt, comprising the steps of
(i) dissolving powdered amylomaltase-treated starch (ATS) in an aqueous composition under heating to a temperature in the range of 50-80° C., followed by
(ii) cooling the solution to a temperature in the range of 2-45° C., preferably 4-25° C., more preferably 4-8° C., to induce the formation of an ATS gel;
(iii) preparing a gelled yoghurt by adding the ATS gel as a pre-formed gel to a conventionally prepared fermented yoghurt; and
(iv) shearing the gelled yoghurt.

3. A method according to claim 1, wherein step (i) comprises dissolving powdered ATS to a temperature in the range of 60-78° C., preferably 70-75° C.

4. A method according to claim 1, wherein the powdered ATS is a non-granular, cold water swellable ATS.

5. A method according to claim 1, wherein the powdered ATS is obtained by treating an amylose-containing starch suspension with amylomaltase (EC 2.4.1.25), preferably wherein said treatment comprises adding amylomaltase to the amylose-containing starch suspension at about 20° C. (room temperature) followed by gradually heating to above the gelatinization temperature of the starch granules to a temperature in the range of about 60-75° C.

6. A method according to claim 1, wherein the ATS is a potato starch, a maize starch, a wheat starch, a rice starch, or a tapioca starch, preferably potato starch.

7. A method according to claim 1, wherein the pre-formed ATS gel is obtained at a temperature between 2° C. and 30° C., preferably between 4° C. and 25° C., more preferably 4 to 8° C.

8. A method according to claim 1, wherein the pre-formed ATS gel is prepared in water, milk, fruit juice, skimmed yoghurt, semi-skimmed yoghurt or full-fat yoghurt, preferably wherein the pre-formed ATS gel is prepared in water or fruit juice.

9. A method according to claim 1, wherein the ATS concentration in the pre-formed ATS gel is between 3 and 15 wt %, preferably 5-12 wt %.

10. A method according to claim 1, wherein step (iii) comprises adding a pre-formed and sheared ATS gel to a yoghurt.

11. A method according to claim 1, wherein the step of shearing comprises shearing the ATS gel to obtain particles characterized by a d-50 of less than about 20 μm.

12. A method according to claim 1, wherein the concentration of ATS in the stabilized drinking yoghurt is between 0.1 and 2 wt %.

13. A method according to claim 1, wherein the drinking yoghurt is a skimmed, semi-skimmed or full-fat drinking yoghurt.

14. A stabilized drinking yoghurt obtainable by a method according to claim 1, characterized in that said drinking yoghurt shows no detectable syneresis and/or sedimentation upon storage at 4° C. for at least 7 days, preferably at last 10 days, more preferably at least 14 days.

15.-19. (canceled)
